(19) United States
(12) Patent Application Publication
(10) Pub. No.: US 2013/0347081 A1
(43) Pub. Date: Dec. 26, 2013

(54) Systems and Methods for Secured Mobile Cellular Communications

(71) Applicants: Peter Rung, Lutz, FL (US); Mary Claire Ryan, Burr Ridge, IL (US)

(72) Inventors: Peter Rung, Lutz, FL (US); Mary Claire Ryan, Burr Ridge, IL (US)

(21) Appl. No.: 13/904,399

(22) Filed: May 29, 2013

Related U.S. Application Data
(63) Continuation-in-part of application No. 11/508,773, filed on Aug. 23, 2006.
Application No. 11/508,773 is a continuation-in-part of application No. 11/890,421, filed on Aug. 6, 2007.
Application No. 11/890,421 is a continuation-in-part of application No. 12/657,497, filed on Jan. 21, 2010.
Application No. 12/657,497 is a continuation-in-part of application No. 12/673,450, filed on Oct. 19, 2011.
(60) Provisional application No. 61/652,829, filed on May 29, 2012.

(51) Int. Cl. H04W 12/08

(52) U.S. Cl. CPC H04W 12/08
USPC 726/4

(57) ABSTRACT

The present subject matter relates to secured mobile off-grid or optionally on-grid cellular communications, providing the ability to operationally provide secured 3G/4G (including further generational advancements in cellular communications), UMTS, HSPA, and LTE cellular communications to a private enclave within a 5-50 kilometer range of an antenna, although the exact communication antenna range is not limited. The communications to and from endpoints consisting of but not limited to smartphones, tablet computers, ruggedized computers, personal computers, etc., may be secured audio, video, text based and file transfers.

The present invention claims priority under 35 U.S.C. 119 to U.S. Provisional Patent Application No. 61/652,829, entitled “Systems and Methods for Secured Mobile Cellular Communications,” filed May 29, 2012. Further, the present invention claims priority as a continuation-in-part application to U.S. patent application Ser. No. 11/508,773, filed Aug. 23, 2006, which claims priority to U.S. Provisional Application No. 60/712,077, filed Aug. 29, 2005 and U.S. Provisional Application No. 60/736,268, filed Nov. 14, 2005. In addition, the present invention claims priority as a continuation-in-part application to U.S. patent application Ser. No. 12/657,497, filed Jan. 21, 2010, which claims priority to U.S. patent application Ser. No. 11/890,421, which claims priority to U.S. Provisional Patent Application No. 61/146,297, filed Jan. 21, 2009. Moreover, the present invention claims priority as a continuation-in-part application to U.S. patent application Ser. No. 12/673,450, filed Feb. 12, 2010, which claims priority to U.S. 60/964,909, filed Aug. 14, 2007. Each of these applications is incorporated herein by reference in its entirety.

### TECHNICAL FIELD

The present subject matter relates to secured mobile off-grid or optionally on-grid cellular communications, providing the ability to operationally provide secured 3G/4G (including further generational advancements in cellular communications), UMTS and HSPA cellular communications to a private enclave within a 5-50 kilometer range of an antenna, although the exact communication antenna range is not limited. The communications to and from endpoints consisting of but not limited to smartphones, tablet computers, ruggedized computers, personal computers, and other like endpoint devices may be secured audio, camera, video, text based and file transfers.

The invention generally consists of commodity items for the wireless cellular-based communications, a satellite communications system, the antennae and mesh network to support current and future cellular methodologies both, with the addition of secured endpoint communications applications on endpoint systems, intrusion detection and prevention solution, a secured VoIP server, and a secured forensic gathering solution. The forensic gathering would include but not limited to any identification, tracking and alerting mechanisms from any attached devices to the tower or any type of receptacle, such as glasses, helmet, small containers to not limit the type of container application from both endpoint systems. This total solution provides the ability to establish secured communications anywhere in the world in an off-grid fashion, providing strong cellular communications for an enclave of individuals requiring local anonymity, yet have the ability to communicate between themselves, with other implementations of the same invention through satellite communications, and with other dedicated secure VoIP servers of the same type.

In addition, the secured communications are implemented by an application on the endpoint devices. The present invention provides the use of endpoint encryption/decryption methodologies, such as those described in U.S. patent application Ser. No. 12/657,497, filed Jan. 21, 2010, and Ser. No. 11/890,421, filed Aug. 6, 2007, incorporated herein by reference in their entireties. For example, endpoint devices utilized in the secure system of the present invention may utilize rotating key methodologies, allowing for users to conduct secured communications, whether audio, camera, video, text, or other like communications, utilizing authentication and encryption methodologies relating to manual and/or automatic initiation of simultaneous multi-encrypted rotating key communication.

In addition, the invention allows for the capture of GPS location to every endpoint connected to it. This allows for asset tracking, and it allows for secured forensics for when a device is lost, stolen, gone rogue, or if the user has been expired. This secured forensic information allows for an enclave team to effectively hunt down the device and perpetrators of the device. In the process and when needed, it becomes an alerting system from one end point to another.

### BACKGROUND

Although the business of cellular communications has made great strides in the past 20 years, there are two areas where cellular carriers have not reached 100% capability: 1) 3G/4G coverage; and 2) secured communications. Regardless of the marketing, there are far more global locations with 2G coverage than any other, and the security of voice, text, camera, video, and other like communication has either had the encryption cracked, or the encryption is non-existent. This leaves gaping holes in robust global secured communications for organizations, which must have both high bandwidth, and communications secured.

In addition, there is the need to have secured communications cloaked, even from the indigenous cellular carrier. That fact remains that there are enemies of the state throughout the world, where the state could be a super power, any one of the G20, or even a sovereign nation growing their industrial status in the world. As a result, espionage is rampant in most every corner of the world. When, therefore, a cellular number appears in a region with a local SIM card or as an international roaming device, introspection of higher than normal bandwidth usage may occur at the carrier, without the user understanding the privacy, or lack thereof, of his communications. All too often, an associate of a drug cartel or terrorist group receives the increase bandwidth communications, and acts on it.

In addition, there is a need for secured forensic tracking of a secure endpoint device. This tracking is required whether the device is nominally operational, or whether it has been compromised.

A series of government and private industries have use for this type of secured mobile and off-grid communications.

An example of the need for the above-described invention can be found in most all communications of large organizations dealing with confidential information. One example would be for law enforcement, allowing law enforcement officials to communicate securely regarding individuals who are breaking the law or engaging in terrorism. These communications could include informants as part of the intelligence process, but also include near real-time communications on any law enforcement individual activity, with the members of enclave or required need-to-know individuals monitoring or assisting the case.

Another example would be the use of the invention for global intelligence gathering. In a similar fashion to law enforcement, the need exists to securely communicate over a secure social network application within an organization, with strategic partners, for tactical operations and with informants, in locations around the world.

Another example is implementation in the precious metals (mining) business, and the energy industry (e.g. oil). Both industries work in the context of rare natural resources sought by existing and new industrial-based countries for expanding economies. Often, these locations are physically located where there is little or no cellular communication available. In these fields, corporate espionage is of strategic geopolitical importance, so much so that the espionage has led recently to major strategic alliances for energy and mineral strategic relationships between the first and third world countries. In these industries, the need for secured communications implemented on a global basis is paramount to the success of multi-decade contracts for both burgeoning nations and rapidly growing first world nations. Secured communications are required for the nations with these new natural resources, and the countries and energy and mineral companies employing billions of dollars in research and development. Major economic and geopolitical positioning is at stake in these scenarios.

Another example of the importance for the present invention is the implementation of several interconnected instances whereby protection details for key executives, governmental or otherwise, are set up, and further requiring mobility. That is, the executives may travel from their jets, to escorted limos, to meeting and/or sleeping facilities, and eventually return to their jets upon execution of meetings. In all steps along a route, support and protection detail may need mobility in communications in a private and secure enclave.

A need, therefore, exists for a communication system and method. Specifically, a need exists for a deployable secured mobile communications system and method that allows for not only communications which cannot be eavesdropped upon, but communications which are cloaked from the local indigenous region wireless communications system.

Moreover, a need exists for a secured communication system, which is mobile, can operate in diverse terrains such as urban, suburban, desert, mountainous, jungle and over water.

Additionally, a need exists for enclave-secured communications with informants and tactical allies in hostile countries where the communications between deployed teams and the locals are secured in communications, but also secured should the endpoint device become compromised. In this case, secured forensic information regarding the compromised state is available via the remote tower communications, but not limited to a tower to include other types of containers to include glasses, helmet and the like, providing the ability for rapid response as necessary. This rapid response can be in a form of an alert from one end user to another.

### SUMMARY OF THE INVENTION

The present subject matter relates to secured mobile off-grid or optionally on-grid cellular communications, providing the ability to operationally provide secured 3G/4G (or generational advancements thereof), UMTS, HSPA and LTE cellular communications to a private enclave within a 5-50 kilometer range of an antenna, although the antenna range may not be limited. The communications to and from endpoints consist of, but are not limited to, smartphones, tablet computers, ruggedized computers, personal computers, and related communication devices that may be fixed to glasses, wristwatches, helmets, or the like, and may include secured audio, video, text-based and file transfers.

The invention consists of commodity items, such as, including the wireless cellular-based communication systems, satellite communication systems, and the antennae to support both, with the additions of secured endpoint communications applications on endpoint systems, intrusion detection and prevention solutions, a secured VoIP server, and a secured forensic gathering solution. This total solution provides the ability to establish secured communications anywhere in the world in an off-grid fashion, provides strong cellular communications for an enclave of individuals requiring local anonymity, yet have the ability to communicate between themselves, with other implementations of the same invention through satellite communications, and with other dedicated secure VoIP servers of the same type.

In addition, the secured communications are provided by the application on the endpoint devices, including, for example, systems and methods for authentication and manual and/or automatic initiation of simultaneous multi-encrypted rotating key communication.

In addition, the invention allows for the capture of GPS location to every endpoint connected to it. This allows for asset tracking, and it allows for secured forensics for when a device is lost, stolen, gone rogue, or if the user has expired. This secured forensic information allows for the enclave team to effectively hunt down the device and purloiners of the device, as well as provide an alerting system.

The invention has two high level basic components associated with it: 1) a series of servers to provide the basic infrastructure for communications; and 2) endpoint applications which serve the end users for sending and receiving all secured communications. The endpoint applications provide all of the private key management mechanisms, symmetric authentication methods, and interfaces with the secure server for multiple factors of authentication.

For the first component area, there are several servers providing different commodity communications. The first is a 3G/4G (including further generational advancements thereof), UMTS, HSPA cellular device which has mobility, can connect with a series of different antenna where each provide either omni-directional or directional characteristics, and each provide differing lengths of communications, from as little as 5 kilometers to more than 50 kilometers. The second system provides the ability to communicate with satellite communications, or over IP-based communications. This back-link capability connects the entire infrastructure based to another instance of the same invention, or with another VoIP server of similar nature somewhere on the planet, be it a datacenter or a cloud implementation.

The other components provide for security services with the endpoints, and provide for security of the infrastructure itself. To accomplish this, a dedicated secure SIP server is implemented. This secure SIP server only operates with the applications on the endpoint devices, and will specifically not operate with a standard SIP client. The secure SIP service may preferably be configured in standalone mode, or, may be back-linked with another secure SIP server of the same type in another mobile configuration, or with another secure SIP server in a datacenter or a cloud. In addition, a high performance intrusion detection and prevention system may be implemented with rules written specifically for protecting the servers in this infrastructure system to protect the infrastructure from any attack, whether the attack vectors in from the cellular server, or the satellite server. If it possible to attack the system, this system will stop the attack vector on the 1st packet of attack. In addition, the intrusion detection and prevention system will also monitor the status and heartbeats of each endpoint device, providing the administrators of the system with friendly and unfriendly status of each device, and their physical location of last known origin. It should be noted that the tracking ability of each endpoint device might be turned on or off, depending on whether further security may be required in any specific implementation of the present invention. However, security protocols may be established to ensure that a compromised endpoint device may not have its tracking capabilities disabled.

To this end, in an embodiment of the present invention, a system for providing secure communications between one or more endpoint devices is provided. The system comprises at least one endpoint device; and a mobile container comprising a cellular server having a private and a secured SIP server integrated therewith, the mobile container controlling communications between the cellular server and the at least one endpoint device.

In an embodiment, the endpoint device is selected from the group consisting of a smartphone, a tablet, a personal computer, glasses, a wristwatch, and a helmet having cellular network capabilities.

In an embodiment, the endpoint device comprises an application thereon for managing the secure communication between the endpoint device and the mobile container.

In an embodiment, the mobile container further comprises an intrusion detection and prevention application interconnected to the private and secured SIP server.

In an embodiment, the intrusion detection and prevention application analyzes communication through the cellular server for intrusion attacks on the communication.

In an embodiment, the mobile container further comprises a satellite server for allowing communication between the tower rack and a satellite.

In an embodiment, communication between the endpoint device and the mobile container is encrypted.

In an embodiment, the communication between the endpoint device and the mobile container is encrypted with rotating keys that change automatically after an event.

In an embodiment, the keys rotate automatically after a period of time elapses.

In an embodiment, the keys rotate automatically after an amount of data is sent between the endpoint device and the tower rack.

In an embodiment, the system further comprises a second endpoint device, wherein the first endpoint device and the second endpoint device communicate directly without routing communication through the cellular server of the tower rack.

In an alternate embodiment of the present invention, a method of providing secure communications between one or more endpoint devices is provided. The method comprises the steps of: providing at least one endpoint device; providing a mobile container comprising a cellular server having a private and a secured SIP server integrated therewith, the mobile container controlling communications between the cellular server and the at least one endpoint device; and routing communication from the endpoint device to the tower rack through the cellular server.

In an embodiment, the endpoint device is selected from the group consisting of a smartphone, a tablet, a personal computer, glasses, a wristwatch, and a helmet having cellular network capabilities.

In an embodiment, the endpoint device comprises an application thereon for managing the secure communication between the endpoint device and the mobile tower rack.

In an embodiment, the mobile container further comprises an intrusion detection and prevention application interconnected with the private and secured SIP server.

In an embodiment, the method further comprises the step of: analyzing communication through the cellular server with the intrusion detection and prevention application for intrusion attacks on the communication.

In an embodiment, the mobile tower rack further comprises a satellite server for allowing communication between the tower rack and a satellite, and further comprising the step of: routing communication from the tower rack through the satellite server to the satellite.

In an embodiment, the method further comprises the step of: encrypting communication between the endpoint device and the tower rack.

In an embodiment, the method further comprises the step of: encrypting the communication between the endpoint device and the mobile tower rack with rotating keys that change automatically after an event.

In an embodiment, the method further comprises the steps of: providing a second endpoint device; and communicating between the first endpoint device and the second endpoint device directly without routing communication through the cellular server of the tower rack.

An advantage of this system provides for operational execution in a global location, without a local signature—effectively cloaked. No other endpoint outside the enclave can interoperate with it.

An advantage of this system provides the users to be part of a private enclave in complete inconspicuous operations due to the cloaking described above, and complete security based on the point-to-point encrypted security for their voice, conference, camera and video, text and file transfer communications.

An advantage of the integrated and dedicated intrusion detection and prevention system is the elimination of attack surfaces, typically servers, by which a perpetrator can perform Man in the Middle (MITM), Distributed Denial of Service (DDOS), or other typical attack vectors against a supposed secure system. The invention eliminates the attack surfaces, thereby leaving it fully protected against standard and popular attack vectors executed by perpetrators.

An advantage of the system is the secured forensic information provided to the administrator from the endpoint devices, which may include GPS location and more, via secured dedicated forensic communications on both the status of the endpoint device and location thereof.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates an exemplary implementation of a secure communication system in an embodiment of the present invention.

FIG. 2 illustrates another exemplary implementation of a secure communication system in an embodiment of the present invention.

### DETAILED DESCRIPTION OF THE PRESENTLY PREFERRED EMBODIMENTS

The present invention relates to secured mobile off-grid or optionally on-grid cellular communications, providing the ability to operationally provide secured 3G/4G (including further generational advancements in cellular communications), UMTS and HSPA cellular communications to a private enclave within a 5-50 kilometer range of an antenna, although the exact communication antenna range is not limited. The communications to and from endpoints consisting of but not limited to smartphones, tablet computers, ruggedized computers, personal computers, etc., may be secured audio, video, text based and file transfers.

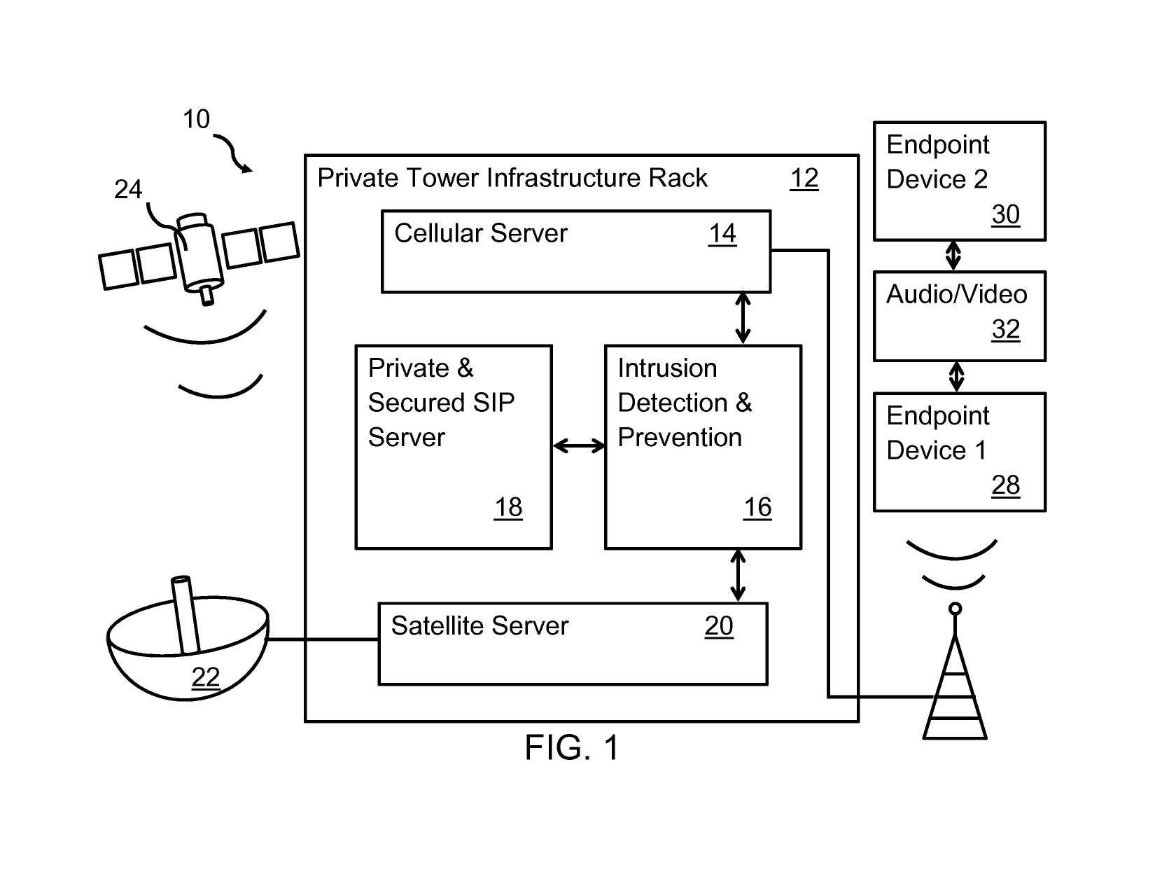

Now referring to the figures, wherein like numerals refer to like parts, FIG. 1 provides a pictorial view of a system 10 in a preferred embodiment of the present invention, consistent with the summary above. It should be noted that although specific hardware and software elements are provided, the present invention may include other hardware and software elements as apparent to one of ordinary skill in the art, and the present invention should not be limited as described herein.

Specifically, the system 10 may comprise a private tower infrastructure rack 12, which may consist, in a preferred embodiment, of one or more 1-N 19″ mobile racks that may be utilized to house the hardware and software components of the present invention. It should be noted, however, that while the present invention describes the system 10 as comprising a “rack” and infrastructure related thereto, the infrastructure may be contained in any container, housing, pack, such as, for example, within a suit case, a back pack, or the like. Moreover, the container may be combined with other hardware or software elements allowing for ease of mobility, such as in vehicles, in carryable packs, in robots, in aerial drones, or other like mobile solutions. The present invention should not be limited as described herein.

The private tower infrastructure rack 12 may include the following components as hardware, software or combinations of hardware and software.

Specifically, the private tower infrastructure rack 12 may comprise a server, preferably a cellular server 16, which may include a commodity 3G/4G (or generational advancements thereof), UMTS, HSPA, multiple frequency cellular appliance. Of course, it should be noted that any other communication server may be implemented and the present invention should not be limited as described herein.

A component of the private tower infrastructure rack 12 may be customized intrusion detection and prevention appliance that may be interconnected with the cellular server, and may be utilized for analyzed data streams into and out of the cellular server 16. The customized intrusion detection and prevention appliance may utilize intrusion detection and prevention components and functionality, such as those described in U.S. patent application Ser. No. 11/508,773, entitled, “System and Method for Communications and Interface with Assets and Data Sets,” Ser. No. 11/890,412, entitled “Systems and Methods for Conducting Secure Wired and Wireless Networked Telephony,” Ser. No. 12/673,450, entitled, “High Performance, High Bandwidth Network Operating System,” and Ser. No. 12/657,497, entitled “Systems and Methods for Simultaneous Integrated Multi-Encrypted Rotating Key Communication,” each of which is incorporated herein by reference in its entirety.

Interconnected to and interacting with the intrusion detection and prevention appliance may be a private and secured SIP server 18, which may be a customized SIP server specific to providing security communications for the applications running on the endpoint devices.

The components specified herein may be connected to a satellite server 20 which may be a standard commodity satellite server that may control communications with a satellite 24 (which may be leased as one would typically lease communication therethrough), and which may communication through a satellite antenna 22, or a dish, such as, preferably, a standard commodity directional satellite antenna that may be portable as required by deployment objectives. This would also include mesh networks and future types of networks.

The cellular server 14 may be connected to a cellular antenna 26, which may preferably be a standard commodity omni-directional or directional cellular antenna, as required by deployment objectives. The cellular antenna 26 may maintain connection with one or more endpoint devices 28, 30, which may be a smartphone, tablet, personal computer, or other like endpoint device that may be incorporated into glasses, a wristwatch, a helmet or the like, and that may run the secure applications thereon to maintain secure communications. The endpoint devices 28, 30 may further have an audio/video path 32, which may be directly between endpoint devices, or point-to-point, instead of through the cellular server 14.

### EXAMPLES

An example of the invention deployment below is for a private deployment with all communications to occur within the users of an enclave. In this example, there are no communications with the outside world.

A private tower infrastructure rack 12 with all infrastructure components described above, including a cellular server 14, an intrusion detection and prevention appliance 16, a private and secured SIP server 18, a satellite server 20 and a satellite antenna 22, may be deployed in a global location, which may include but is not limited to an urban, suburban, desert, mountainous, jungle or on the water location. Additionally, the location may be fixed or mobile. In advance of deployment, the proper antenna configurations for both satellite and cellular ranges and type are engineered and deployed.

The cellular server 14 may be configured for N number of endpoint devices 28, 30 to communicate with the private tower infrastructure rack 12. The types of communications may be tuned to the endpoint device capabilities. Additionally, the cellular frequencies used are not within the range of any carrier of where the private tower infrastructure rack 12 may be deployed. These features effectively electronically cloak the existence of the deployment.

The customized intrusion detection and prevention appliance 16 may be configured with private rules to thwart any standard and known VoIP attack, as well as DDOS attacks. This is true for communications coming from the cellular server 14 and/or the satellite server 20.

The customized intrusion detection and prevention appliance 16 may also be configured to collect and alert about the status of each endpoint device. This may include whether the endpoint device is active, or has gone rogue, is lost, stolen, or if the user has been physically compromised.

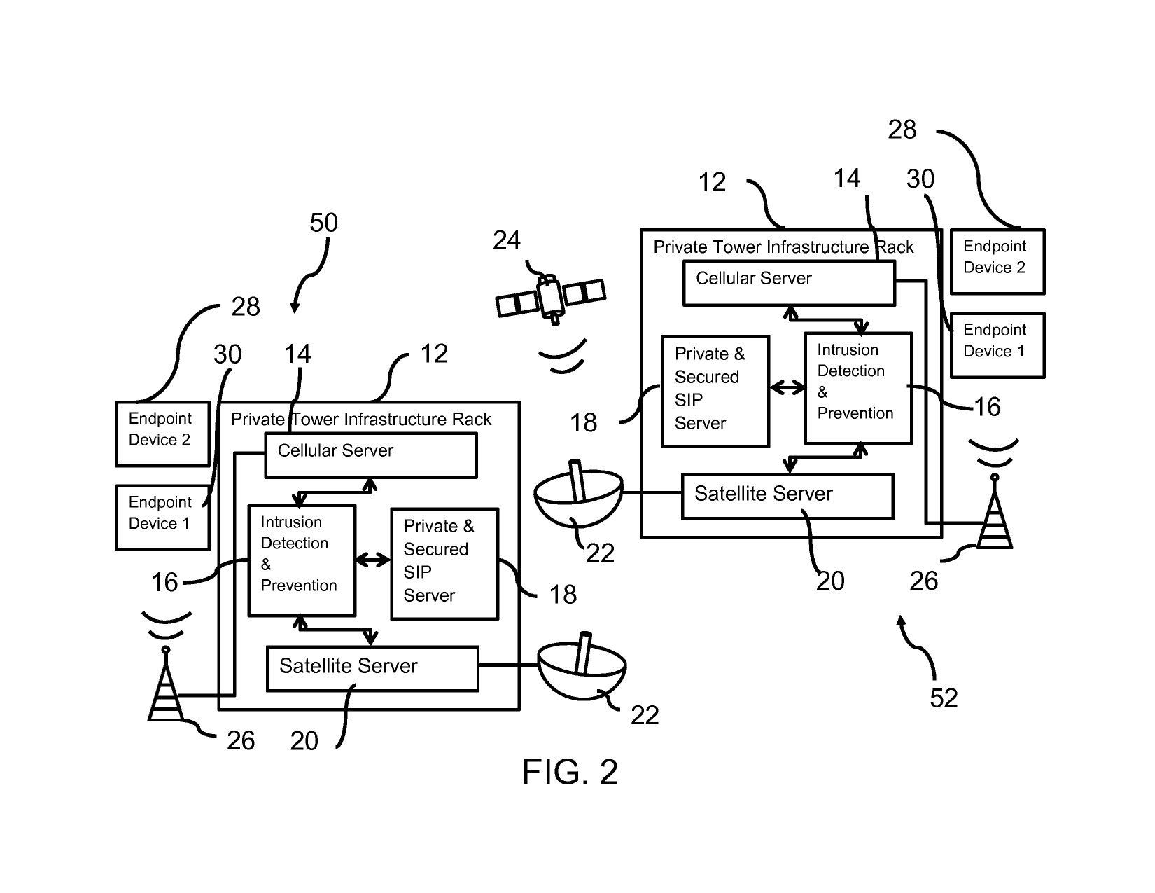

Satellite server 20 may be configured to actively be connected to a satellite providing a linkage between the satellite server 20 and another instance of it in another private tower configuration (as illustrated in FIG. 2), or with a similar server located in a datacenter or a cloud.

Endpoint devices 28, 30 may be configured to register with the private and secured SIP server 18 upon activation. All functionality of authentication and key creation, management, and distribution may occur from the endpoint devices. In this fashion, all of the communications stemming from an endpoint may be secured from the very first packet. Additionally, the audio/video path of communications within the proximity of this private tower infrastructure rack 12 implementation will occur directly from one endpoint to another, bypassing a path through private and secured SIP server 18. For example, each endpoint device may be tethered to each other through its own network, such as in a mesh network or the like, not requiring direct communication paths through the cellular server 14.

In another implementation of the invention, a second private tower infrastructure rack 52, may be deployed in another location globally, or locally close to a first implementation 50, each of which has internal components of hardware and software as described above with respect to system 10. In the first instance, all communications to a second enclave of endpoint devices that may be configured to the second rack 52 will have the ability to communicate to the members of the first enclave supported by the first rack. In this deployment, communications between these users will occur by configuring the private and secured SIP servers 18 in each rack, to recognize the other private and secured SIP server in the other rack. As a result, the audio and video traffic will not be point to point, but will traverse through the private and secured SIP servers 18, then through the other components described herein to the other installation, traversing that infrastructure in reverse order, and then eventually to the other endpoint device or devices.

There is no limit to the number of infrastructures that may be supported by the present invention. However, the limit to the number of endpoint devices may be defined by the limitations of the Cellular Server 14.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A system for providing secure communications between one or more endpoint devices comprising:
at least one endpoint device; and
a mobile container comprising a cellular server having a private and a secured SIP server integrated therewith, the mobile container controlling communications between the cellular server and the at least one endpoint device.

2. The system of claim 1 wherein the endpoint device is selected from the group consisting of a smartphone, a tablet, a personal computer, glasses, a wristwatch, and a helmet having cellular network capabilities.

3. The system of claim 1 wherein the endpoint device comprises an application thereon for managing the secure communication between the endpoint device and the mobile container.

4. The system of claim 1 wherein the mobile container further comprises an intrusion detection and prevention application interconnected to the private and secured SIP server.

5. The system of claim 4 wherein the intrusion detection and prevention application analyzes communication through the cellular server for intrusion attacks on the communication.

6. The system of claim 1 wherein the mobile container further comprises a satellite server for allowing communication between the mobile container and a satellite.

7. The system of claim 1 wherein communication between the endpoint device and the mobile container is encrypted.

8. The system of claim 7 wherein the communication between the endpoint device and the mobile container is encrypted with rotating keys that change automatically after an event.

9. The system of claim 8 wherein the keys rotate automatically after a period of time elapses.

10. The system of claim 8 wherein the keys rotate automatically after an amount of data is sent between the endpoint device and the mobile container.

11. The system of claim 1 further comprising:
a second endpoint device, wherein the first endpoint device and the second endpoint device communicate directly without routing communication through the cellular server of the mobile container.

12. A method of providing secure communications between one or more endpoint devices comprising the steps of:
providing at least one endpoint device;
providing a mobile container comprising a cellular server having a private and a secured SIP server integrated therewith, the mobile container controlling communications between the cellular server and the at least one endpoint device; and
routing communication from the endpoint device to the mobile container through the cellular server.

13. The method of claim 12 wherein the endpoint device is selected from the group consisting of a smartphone, a tablet, a personal computer, glasses, a wristwatch, and a helmet having cellular network capabilities.

14. The method of claim 12 wherein the endpoint device comprises an application thereon for managing the secure communication between the endpoint device and the mobile container.

15. The method of claim 12 wherein the mobile tower rack further comprises an intrusion detection and prevention application interconnected with the private and secured SIP server.

16. The method of claim 15 further comprising the step of:
analyzing communication through the cellular server with the intrusion detection and prevention application for intrusion attacks on the communication.

17. The method of claim 12 wherein the mobile container further comprises a satellite server for allowing communication between the mobile container and a satellite, and further comprising the step of:
routing communication from the mobile container through the satellite server to the satellite.

18. The method of claim 12 further comprising:
encrypting communication between the endpoint device and the mobile container.

19. The method of claim 18 further comprising the step of:
encrypting the communication between the endpoint device and the mobile container with rotating keys that change automatically after an event.

20. The method of claim 12 further comprising:
providing a second endpoint device; and
communicating between the first endpoint device and the second endpoint device directly without routing communication through the cellular server of the mobile container.
